(19) United States
(12) Patent Application Publication
(10) Pub. No.: US 2002/0137552 A1
(43) Pub. Date: Sep. 26, 2002

(54) Indication unit for a portable wireless device

(76) Inventors: Joseph M. Cannon, Harleysville, PA (US); James A. Johanson, Macungie, PA (US); Philip D. Mooney, Sellersville, PA (US)

Correspondence Address: DICKSTEIN SHAPIRO MORIN & OSHINSKY LLP, 2101 L STREET NW, WASHINGTON, DC, 20037-1526, US

(21) Appl. No.: 09/811,614

(22) Filed: Mar. 20, 2001

(51) Int. Cl. H04M 1/00

(52) U.S. Cl. 455/567; 455/41; 455/564; 455/456

(57) ABSTRACT

An indication unit for use with a portable wireless device is provided. The indication unit senses, via a proximity detector, that the user has returned to the vicinity of the portable wireless device sometime after the device has been in a stationary position and reminds the user of some important pending message through the use of a predetermined user indication. The portable wireless device may be a wireless telephone unit, a personal digital assistant (PDA), a short message service (SMS) device, a pager, or any other portable wireless device capable of storing a message of such a nature that a user would want to be notified and/or reminded of its existence in quick fashion upon returning to the vicinity of the wireless device.

### BACKGROUND OF THE INVENTION

1. Field of the Invention:

The present invention relates to portable wireless devices. More specifically, it relates to indicating stored messages and announcements in portable wireless devices.

2. Description of Prior Art:

Portable wireless devices have become commonplace in recent years. In fact, one can hardly walk the streets without encountering multiple persons communicating via a wireless telephone, or consulting a wireless personal digital assistant (PDA), short messaging service (SMS) device or pager.

In addition to standard telephony features, modern day wireless telephones come equipped with a voice mail service in which a predetermined outgoing message is transmitted when an incoming call is received and the user has not answered the telephone call within a predetermined number of rings. The predetermined outgoing message prompts the caller to leave a message for the user which will be stored until the user retrieves the message at a later time. The wireless telephone will store the messages and provide an indication of a received and stored message to a user. Likewise, other wireless message receiving devices, such as pagers, PDA's etc., also can receive and store messages and provide an indication to a user of a received and stored message.

In many instances, many portable wireless devices are also able to store an annunciation message as a reminder for an appointment or other event, e.g., a birthday, and this too is indicated to a user. When the user has the portable wireless device on his person, he can readily see that an incoming message has been received and stored or that an annunciation message is available. For example, for a wireless telephone or PDA, or pager, a typical message-waiting indicator might be a flashing envelope to signify there is a message waiting. For other wireless devices, an available annunciation message may be indicated by another display icon.

However, when the user has removed the portable wireless device from his person, for example, when he visits a gym, not only will the user not receive an incoming message at the time it is placed or an annunciation message when available, but the user may not receive the message for an extended period of time after the user has returned to retrieve the portable wireless device. For example, if the user places the portable wireless device in his locker, he will not be available to receive pending messages for a certain period of time. When the user retrieves the wireless device, e.g., he returns from the gym and into the locker room where the device is stored, the user may not immediately see the visual message indicator and will not be notified of the pending message until the user notices a message-waiting indicator (e.g., the flashing envelope or other icon). The period of time that lapses between when the user returns to the vicinity of the portable wireless device and when the user actually notices a message-waiting indicator may be undesirably long.

It is thus desirable to equip portable wireless devices, such as wireless telephones, pagers, PDA's, etc., with an indicator unit that is capable of sensing that the user has returned to the vicinity of the wireless device, and immediately notifying the user of a pending message, before the user actually notices the normal message-waiting indicator (e.g., flashing envelope).

### SUMMARY OF THE INVENTION

The present invention provides an indication unit for use with a portable wireless device. The indication unit senses, via a proximity detector, that the user has returned to the vicinity of the portable wireless device sometime after the user has left and indicates a newly stored message to a user through the use of a predetermined user indication which is different from the normal message waiting indicator associated with the portable wireless device. The portable wireless device may be a wireless telephone unit, a PDA, a short message service (SMS) device, a pager, or any other portable wireless device capable of storing a message of such a nature that a user would want to be notified and/or reminded of its existence in quick fashion upon returning to the vicinity of the wireless device so that he can immediately retrieve the pending message.

### BRIEF DESCRIPTION OF THE DRAWINGS

The foregoing and other advantages and features of the invention will become more apparent from the detailed description of preferred embodiments of the invention given below with reference to the accompanying drawings in which:

FIG. 1 is an indication unit in accordance with an exemplary embodiment of the invention;

FIG. 2 is a flowchart depicting an operational flow of a method in accordance with an exemplary embodiment of the invention;

FIG. 3 depicts a portable device which includes the indication unit of FIG. 1 in accordance with an exemplary embodiment of the invention;

FIG. 4 depicts a BLUETOOTH™ piconet which includes a portable device such as that depicted in FIG. 2; and

FIG. 5 depicts a semiconductor chip in accordance with an exemplary embodiment of the invention.

### DETAILED DESCRIPTION OF PREFERRED EMBODIMENTS

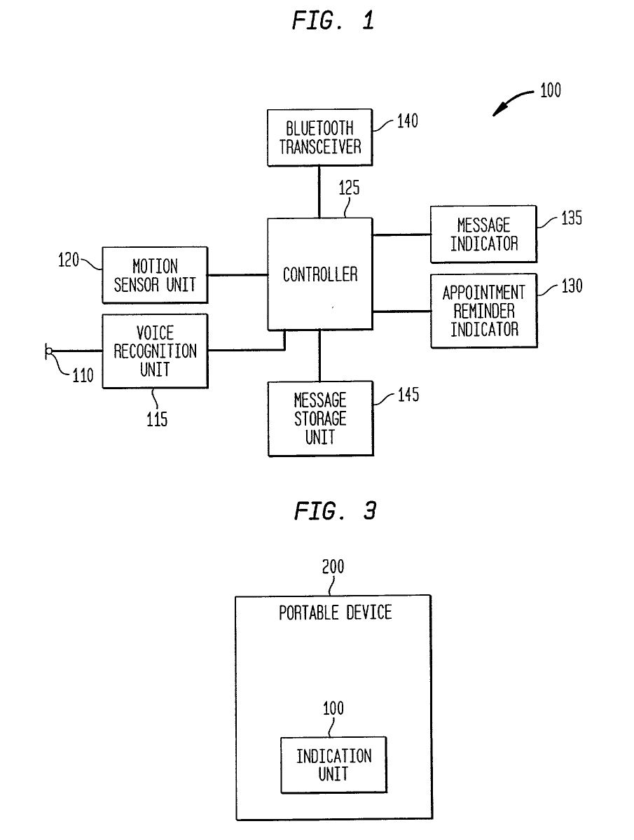

The present invention will be described as set forth in exemplary embodiments described below in connection with FIGS. 1-5. Other embodiments may be realized and other changes may be made to the disclosed embodiments without departing from the spirit or scope of the present invention.

Referring now to FIG. 1, an indication unit 100 is depicted in accordance with an exemplary embodiment of the present invention. Controller 125 is coupled to at least one proximity detector for detecting when a user has both left the vicinity and returned to the vicinity of the portable wireless device. One or more of several different types of proximity detectors can be used in the invention and several types of proximity detectors are shown in FIG. 1. Typical examples of proximity detectors which may be used with the invention include motion sensors (e.g., 120) such as e.g., accelerometers, voice recognition units (e.g., 115), BLUETOOTH™ transceivers (e.g., 140), etc. Additionally, it should be pointed out that global positioning system (GPS) technology may be employed by motion sensor 120. Using GPS technology, motion sensor 120 is able to sense when the portable wireless device, which includes indication unit 100, is in a stationary position and also when the device has been moved from the stationary position. In addition, using GPS technology, motion sensor 120 is able to sense when the user has both left the vicinity and returned to the vicinity of the portable wireless device when the user's location is tracked by such GPS technology (e.g., if the user is wearing a GPS-equipped device such as a watch).

Upon leaving the portable wireless device in a stationary position (e.g., in a locker at the gym) for a predetermined period of time (e.g., one minute), one, some or all of the proximity detectors send an appropriate control signal to controller 125. Upon receiving the control signal, controller 125 monitors a message storage unit (e.g., 145 of FIG. 1) for any messages received after the wireless device has been placed in the stationary position and before the user has returned to the vicinity of the wireless device. In a preferred embodiment of the invention, motion sensor 120 is an accelerometer because the operation of accelerometers is well known in the art and also because accelerometers are readily available, relatively inexpensive and easily implemented.

Controller 125 may be a processor-based device, a central processing unit of a computer, an application specific integrated circuit, a digital signal processor, etc. Preferably, controller 125 is a controller already present in a portable wireless device which controls the operations of the portable wireless device. Controller 125 is coupled to at least one user notification unit for notifying the user of a newly stored message requiring his immediate attention. A first user notification unit coupled to controller 125 is a received message waiting indicator 135. A second user notification unit coupled to controller 125 is an appointment reminder message indicator 130. Although two separate indicators 130, 135 are illustrated, the invention may also be implemented with a single message indicator for both received messages and reminder messages.

A first proximity detector which may be coupled to and used with controller 125 is a BLUETOOTH™-enabled transceiver 140. BLUETOOTH™-enabled transceiver 140 is a specialized transceiver that is configured to a standard called the BLUETOOTH™ specification. The BLUETOOTH™ specification, which can be found at www.Bluetooth.com contains the information required to ensure that diverse devices supporting the BLUETOOTH™ wireless technology can communicate with each other worldwide. The BLUETOOTH™ specification defines two different power levels: a lower power level that covers a shorter personal area within a room and a higher power level that can cover a medium range such as within a home. For purposes of the present invention, the low power level is appropriate.

Software controls and identity coding built into each BLUETOOTH™-enabled transceiver (e.g., 140) ensure that only those units preset by their owners can communicate with each other using the BLUETOOTH™ standard. The BLUETOOTH™ wireless technology supports both point-to-point and point-to-multipoint connections. With the current specification, up to seven “slave” devices can be set to communicate with a “master” radio located in one device. Several piconets can be established and linked together in ad hoc scatter nets to allow communication among continually flexible configurations. All devices in the same piconet have priority synchronization but other devices can be set to enter at any time.

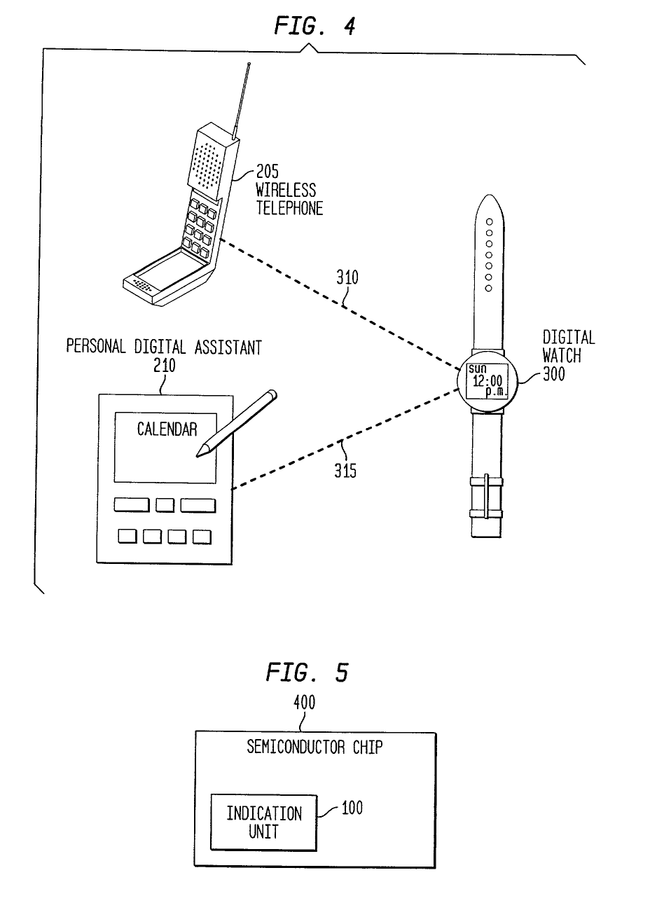

With reference to FIG. 1, BLUETOOTH™-enabled transceiver 140 is configured to communicate with another BLUETOOTH™-equipped device. For example, when a user wearing a BLUETOOTH™-equipped digital watch (e.g., 300 of FIG. 4) is in the vicinity of the indication unit 100, which is located inside of or attached to a portable wireless device, in accordance with an embodiment of the invention, a communication channel (e.g., 310 of FIG. 4) is automatically established between the two BLUETOOTH™-equipped devices 140, 300. When the user wearing the watch 300 leaves the vicinity of the BLUETOOTH™-enabled transceiver 140, the communication channel 310 is broken and an appropriate control signal is sent to controller 125. When the communication channel 310 is broken, controller 125 begins to monitor message storage unit 145 for a newly received message.

When the user returns to the vicinity of the wireless device, the communication link 310 is reestablished between watch 300 and transceiver 140 and the BLUETOOTH™ transceiver 140 sends a control signal to the controller 125 which then consults message storage unit 145 and determines whether a new message has been received during the time period in which the communication channel 310 was broken. If yes, controller 125 then sends a control signal to either one or both of the received message waiting indicator 135 and the appointment reminder message indicator 130, depending on the nature of the message. Depending on the type of device which contains the indication unit 100 and the nature of the message (voice message, text message, appointment or other reminder message, etc.), either one of the indicators 135 or 130, or both, will be activated to notify the user of the pending message which requires his immediate attention. As noted, it is also possible to provide a single message indicator which is activated so as to get the attention of the user whenever a message becomes pending when the user is away from the portable wireless device.

As noted, a pending message requiring the user's attention may be an incoming message, e.g., incoming phone message, or a message indicating an upcoming appointment, birthday, or other event, etc. In such a case, when controller 125 receives a control signal from the proximity detector, it checks the message storage unit 145 for a message set there.

If the message is a reminder message, it may come from a scheduling program being run by the portable wireless device. The scheduling program would automatically set a reminder message in message storage unit 145 upon reaching a predetermined time (e.g., one day, several hours, etc.) prior to an upcoming appointment or other event. If such a “tickler” message is set in message storage unit 145 while the portable wireless device is stationary, the device of the invention would automatically notify the user of the pending message upon his returning to the vicinity of the device.

Still referring to FIG. 1, the indication unit 100 may also be equipped with a motion sensor 120 (e.g., an accelerometer), as a proximity detector, to sense both when the portable wireless device has been left in a stationary position for some time period and also to sense when the portable wireless device containing the indication unit 100 is subsequently moved from the stationary position. If motion sensor 120 is used when a user moves the portable wireless device, indication unit 100 will check for pending messages and notify the user of same by one or both of notification units 135, 130 as appropriate.

A voice recognition unit 115 may also be used as a proximity detector. Voice recognition unit 115, coupled to microphone 110, is capable of recognizing when the user has returned to the vicinity of the portable device in that, if the user speaks audibly within the vicinity of the portable device, voice recognition unit 115 detects the user's voice. For example, the controller 125 receives a control signal from the voice recognition unit 115, or other proximity sensor, indicating that the device is stationary. When voice recognition unit 115 subsequently recognizes the user's voice, thus signifying the user has returned to the vicinity of the device, controller 125 determines whether a pending message is present in message storage unit 145. If yes, controller 125 sends an appropriate control signal to one or both of message indicators 130, 135.

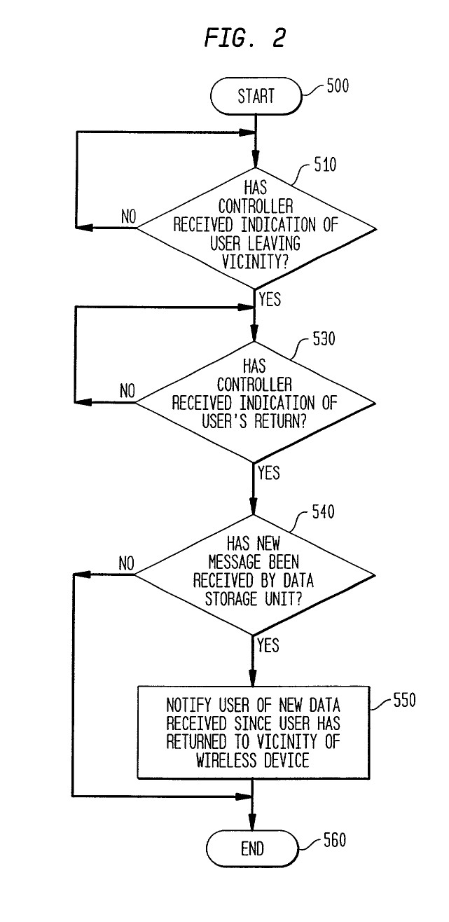

Turning now to FIG. 2, an operational flow of a method implemented in conjunction with controller 125 is shown. The flow begins at start processing segment 500. At processing segment 510, controller 125 determines whether the user has left the vicinity of the wireless device. Controller 125 does this by receiving a control signal, from at least one of the proximity sensors described above in connection with FIG. 1, that the user has left the vicinity of the portable wireless device. For example, with the BLUETOOTH™ transceiver 140 proximity detector, if the BLUETOOTH™ communication is broken, this indicates that the user has left. The motion sensor 120 if implemented with a GPS receiver may indicate that the user has left by, for example, noting no change in GPS coordinates of the indicator 100 for some period of time. If motion sensor 120 is implemented with an accelerometer, it will detect lack of motion of the portable wireless device. Voice recognition unit 115 may interpret lack of voice input as indicating that the user has left.

At processing segment 530, controller 125 determines whether it has received an indication that the user has returned to the proximity of the wireless device. That is, controller 125 checks to see if it has received a control signal from at least one of the proximity sensors described above in connection with FIG. 1 that the user has returned. If a control signal has not been received, segment 530 is repeated; if a control signal has been received, the process flow continues to segment 540. At processing segment 540, controller 125 determines whether a new message has been received by message storage unit 145 during the user's absence. If not, the process flow ends. If yes, controller 125 notifies the user of the existence of a new message by sending a control signal to message indicator 130 and/or 135 as appropriate for the pending message.

Turning now to FIG. 3, a portable device 200 is depicted as including an indication unit 100. Indication unit 100 is identical to indication unit 100 of FIG. 1 in configuration and operates as described in the process flow of FIG. 2. Portable device 200 may be a wireless telephone device, a PDA, a pager, an SMS receiver, or any other portable wireless device which is capable of storing a message of such a nature that a user would want to be notified and/or reminded of its existence in quick fashion upon returning to the vicinity of the portable wireless device 200.

Turning now to FIG. 4, a BLUETOOTH™ piconet is depicted in accordance with an exemplary embodiment of the invention. A wireless telephone 205, which includes the indication unit 100 (of FIG. 1), is depicted as having established a communication channel 310 with a second BLUETOOTH™-equipped device 300 (e.g., a digital watch). In addition, a PDA 210 may be included in the FIG. 4 BLUETOOTH™ piconet. PDA 210 contains an indication unit 100 identical to that located within wireless telephone 205. The operation of the BLUETOOTH™ transceiver 140 located in PDA 210 is identical to that described above in connection with wireless telephone 205. The establishment and breaking of communication channel 305 is identical to that of channel 310 as described above. Upon reestablishing communication channel 315 (i.e., upon the user's return to the vicinity of the wireless PDA 210), BLUETOOTH™ transceiver 140 sends a control signal to controller 125. If a new message has been received while the user was away, controller 125 sends an appropriate control signal to message indicator 130 and/or 135, depending on the nature of the pending message.

Turning now to FIG. 5 a semiconductor chip 400 is depicted as including an indication unit 100. The configuration and operation of indication unit 100 are identical to that as described in connection with FIG. 1. Semiconductor chip 400 is a manufactured device for use within a portable wireless device such as those described in connection with FIGS. 3 and 4. In addition to indication unit 100, semiconductor chip 400 may include any number of components, devices and conductors depending upon the type of portable wireless device.

The present invention provides an indication unit 100 as described in connection with FIG. 1 which may be included within any number of portable wireless devices. Indication unit 100 is capable of sensing when the user has returned to the vicinity of the portable wireless device and of notifying the user of newly stored (pending) messages which occurred in the user's absence upon sensing the user's return.

The particular type of user indication used to notify the user of the new message is not critical; however, the indication will be of such a nature so as to notify the user of the pending message quicker than the indications currently available. For example, the user indication 130 and/or 135 might be an audible signal, a vibration, flashing lights or other indication which a user will quickly notice upon his return to a portable wireless device.

While the invention has been described in detail in connection with preferred embodiments known at the time, it should be readily understood that the invention is not limited to the disclosed embodiments. Rather, the invention can be modified to incorporate any number of variations, alterations, substitutions or equivalent arrangements not heretofore described, but which are commensurate with the spirit and scope of the invention. For example, although the invention has been described in the context of a received message indicator and an appointment reminder message indicator, it should be readily understood that any information capable of being retrieved by a user via a portable wireless device may be provided to such a user in connection with the indication unit 100 described herein. In addition, while the invention has been described in connection with several exemplary proximity detection devices, the invention may be practiced by sensing any indication that the user has returned to the vicinity of the device. Furthermore, the controller 125 may be a stand alone controller or a controller which is already within a portable wireless device.

Accordingly, the invention is not limited by the foregoing description or drawings, but is only limited by the scope of the appended claims.

What is claimed as new and desired to be protected by Letters Patent of the United States is:

1. An indication unit for use with a portable wireless device, the indication unit comprising:
a proximity detector for detecting when a user has returned to the vicinity of the portable wireless device and for generating a signal indicating that the user has returned;
a user notification unit for providing a message indication to a user; and
a controller responsive to receipt of said signal for activating said user notification unit to notify a user that a message arrived while said user was not in the vicinity of the portable wireless device.

2. The indication unit of claim 1, wherein the portable wireless device is a telephone.

3. The indication unit of claim 1, wherein the portable wireless device is a personal digital assistant.

4. The indication unit of claim 1, wherein the portable wireless device is a short message service (SMS) device.

5. The indication unit of claim 1, wherein the portable wireless device is a pager.

6. The indication unit of claim 1, wherein the proximity detector comprises a BLUETOOTH™-enabled transceiver for establishing a communication channel with another BLUETOOTH™-equipped device.

7. The indication unit of claim 1, wherein the proximity detector comprises a motion sensor for sensing when said portable wireless device has been moved from a stationary position.

8. The indication unit of claim 7, wherein the motion sensor utilizes a global positioning system (GPS) receiver to detect motion.

9. The indication unit of claim 8, wherein the portable wireless device detects motion by sensing changes in its own position.

10. The indication unit of claim 1, wherein the portable wireless device comprises a GPS receiver for receiving GPS location information and a receiver for receiving GPS location information transmitted to said portable wireless device from the user.

11. The indication unit of claim 1, wherein the proximity detector comprises a voice recognition unit for recognizing the user's voice when the user has returned to the vicinity of the portable device.

12. The indication unit of claim 1, wherein the user notification unit comprises a message indicator for informing the user of a pending message.

13. The indication unit of claim 12, wherein the portable wireless device is a telephone and the pending message is a voice mail.

14. The indication unit of claim 1, wherein the indication provided to the user comprises an audible indication.

15. The indication unit of claim 1, wherein the indication provided to the user comprises a vibration of the portable wireless device.

16. The indication unit of claim 1, wherein said message comprises an appointment reminder.

17. The indication unit of claim 1, wherein said indication unit is located on an integrated circuit chip.

18. A portable wireless device comprising:
an indication unit, said indication unit comprising:
a proximity detector for detecting when a user has returned to the vicinity of the portable wireless device and for generating a signal indicating that the user has returned;
a user notification unit for providing a message indication to a user; and
a controller responsive to receipt of said signal for activating said user notification unit to notify a user that a message arrived while said user was not in the vicinity of the portable wireless device.

19. The device of claim 18, wherein the proximity detector comprises a BLUETOOTH™-enabled transceiver for establishing a communication channel with another BLUETOOTH™-equipped device associated with said user.

20. The device of claim 18, wherein the proximity detector comprises a motion sensor for sensing when said portable wireless device has been moved from a stationary position.

21. The device of claim 20, wherein the motion sensor utilizes a global positioning system (GPS) receiver to detect motion.

22. The device of claim 21, wherein the device detects motion by sensing changes in its own position.

23. The device of claim 21, wherein the device comprises a GPS receiver for receiving GPS location information and a receiver for receiving GPS location information transmitted to said device from the user.

24. The device of claim 18, wherein the proximity detector comprises a voice recognition unit for recognizing the user's voice when the user has returned to the vicinity of the portable device.

25. The device of claim 18, wherein the user notification unit comprises a message indicator for informing the user of a pending message.

26. The device of claim 25, wherein the device is a telephone and the pending message is a voice mail.

27. The device of claim 18, wherein the indication provided to the user comprises an audible indication.

28. The device of claim 18, wherein the indication provided to the user comprises a vibration of the device.

29. The device of claim 18, wherein said portable wireless device comprises a wireless telephone.

30. The device of claim 18, wherein said portable wireless device comprises a personal digital assistant.

31. The device of claim 18, wherein said portable wireless device comprises a short message service (SMS) device.

32. The device of claim 18, wherein said portable wireless device comprises a pager.

33. The device of claim 18, wherein said message comprises an appointment reminder.

34. The device of claim 18, wherein said indication unit is provided on an integrated circuit chip.

35. The device of claim 18, wherein said proximity detector and said user notification unit are provided on an integrated circuit chip.

36. A method for operating a portable wireless device, the method comprising:
detecting when a user has returned to the vicinity of said portable wireless device; and
notifying the user that a message had occurred while the user was not in the vicinty of the portable wireless device.

37. The method of claim 36, wherein said act of detecting comprises establishing a BLUETOOTH™ communication channel between said portable wireless device and with a user-carried BLUETOOTH™ device.

38. The method of claim 36, wherein said act of detecting comprises sensing that said portable wireless device has been moved from a stationary position.

39. The method of claim 38, wherein said act of sensing comprises utilizing a global positioning system (GPS) receiver to detect changes in the portable wireless device's position.

40. The method of claim 39, further comprising comparing GPS location information of the portable wireless device with GPS location information transmitted to said portable wireless device from the user.

41. The method of claim 36, wherein said act of detecting comprises detecting an audio output from said user.

42. The method of claim 36, wherein said act of notifying comprises providing the user with a pending message indication.

43. The method of claim 42, wherein said act of providing comprises providing the user with an audible indication.

44. The method of claim 42, wherein said act of providing comprises providing the user with a vibration indication.
